(19) United States
(12) Patent Application Publication
(10) Pub. No.: US 2018/0040095 A1
(43) Pub. Date: Feb. 8, 2018

(54) DYNAMIC COMPRESSED GRAPHICS STATE REFERENCES

(71) Applicant: QUALCOMM Incorporated, San Diego, CA (US)

(72) Inventors: Avinash Seetharamaiah, San Diego, CA (US); Christopher Paul Frascati, Oviedo, FL (US); Jonnala Gadda Nagendra Kumar, Aliso Viejo, CA (US); Andrew Evan Gruber, Arlington, MA (US); Colin Christopher Sharp, Cardiff, CA (US); Eric Demers, San Diego, CA (US)

(21) Appl. No.: 15/226,627

(22) Filed: Aug. 2, 2016

(51) Int. Cl. G06T 1/20; G06T 1/60

(52) U.S. Cl. CPC G06T 1/20; G06T 1/60; G06T 2200/28

(57) ABSTRACT

This disclosure describes techniques for compressing a graphical state object. In one example, a central processing unit may be configured to receive, for output to the GPU, a set of instructions to render a scene. Responsive to receiving the set of instructions to render the scene, the central processing unit may be further configured to determine whether the set of instructions includes a state object that is registered as corresponding to an identifier. Responsive to determining that the set of instructions includes the state object that is registered as corresponding to the identifier, the central processing unit may be further configured to output, to the GPU, the identifier that is registered as corresponding to the state object.

### TECHNICAL FIELD

This disclosure relates to graphics processing, including techniques for architectures using a command buffer.

### BACKGROUND

Some example graphics architectures increased a number of registers in a graphics processing unit (GPU) to permit each application program interface (API) object to be implemented in its own register. Since each API object has its own register, each orthogonal state in the API was provided a hardware register state and the driver updated each API object immediately, rather than waiting for a draw call operation. As such, implementing each API object in its own register simplified the rendering process, since tracking dirty bits (e.g., hardware states used to generate tiles or portions of an image that require updating before the draw call operation) was no longer necessary. More recently, in order to reduce driver overhead, APIs have introduced the concept of a pipeline state object. The pipeline state object concept permits a collection of several tightly coupled states (e.g., shaders and a blend state) to be encapsulated as a single state object that results in multiple API objects being implemented in a single register. In practice, pipeline state objects will frequently include individual states that are duplicated across multiple pipeline state objects.

### SUMMARY

In general, this disclosure describes techniques for identifying non-unique states across unique state objects to reduce an amount of data used to reference the state objects containing the same content. Said differently, rather than necessarily explicitly communicating, from a driver to a graphics processing unit (GPU), a single state object multiple times, this disclosure describes techniques for identifying state objects that are used multiple times to reduce an amount of data communicated, from the driver, to the GPU, thereby reducing an amount of data communicated in a command buffer.

For example, in response to a driver determining that non-unique states are to be duplicated across unique state objects, the driver may register, with the GPU, the non-unique states as corresponding to a unique identifier. In the example, in response to receiving an instruction to communicate the non-unique state registered as corresponding to a unique identifier to the GPU, the driver may communicate, to the GPU, the unique identifier that corresponds to the non-unique state for the unique state object rather than explicitly communicating the entire state object (e.g., explicitly communicating the non-unique state for the unique state object). In examples of the disclosure, the GPU may fetch the entire state registered as corresponding to a unique identifier from a cache of the GPU, an on-board memory, or another storage element. In this manner, an amount of data transmitted in command stream communications from the driver to a command processor of the GPU may be reduced in order to reduce a bandwidth of a command stream used by the driver and to improve processing efficiency.

In one example, this disclosure describes a method including receiving, by a driver, for output to a GPU, a set of instructions to render a scene. Responsive to receiving the set of instructions to render the scene, the method includes determining, by the driver, whether the set of instructions includes a state object that is registered as corresponding to an identifier. Responsive to determining that the set of instructions includes the state object that is registered as corresponding to the identifier, the method includes outputting, by the driver, to the GPU, the identifier that is registered as corresponding to the state object.

In another example, this disclosure describes a device including a central processing unit (CPU) and a GPU. The GPU is configured to render a scene, wherein the graphics processing unit has an on-chip memory. The CPU is configured to receive, for output to the GPU, a set of instructions to render a scene. Responsive to receiving the set of instructions to render the scene, the CPU may be further configured to determine whether the set of instructions includes a state object that is registered as corresponding to an identifier. Responsive to determining that the set of instructions includes the state object that is registered as corresponding to the identifier, the CPU may be further configured to output, to the GPU, the identifier that corresponds to the state object.

In another example, this disclosure describes a computer-readable storage medium having instructions stored thereon that, when executed, cause one or more processors of a computing device to receive, for output to a GPU, a set of instructions to render a scene. Responsive to receiving the set of instructions to render the scene, the instructions, when executed, further cause the one or more processors of the computing device to determine whether the set of instructions includes a state object that is registered as corresponding to an identifier. Responsive to determining that the set of instructions includes the state object that is registered as corresponding to the identifier, the instructions, when executed, further cause the one or more processors of the computing device to output, to the GPU, the identifier that is registered as corresponding to the state object.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram showing an example computing device configured to use the techniques of this disclosure.

FIG. 2 is a block diagram showing components of FIG. 1 in more detail.

FIG. 3 is a flowchart showing an example method consistent with one or more techniques of this disclosure.

FIG. 4 is an illustration showing an exemplary operation consistent with techniques of this disclosure.

### DETAILED DESCRIPTION

In general, the techniques of this disclosure are directed to efficiently communicating state objects and command stream information between a driver and a graphics processing unit (GPU). Such communication of state objects and command stream information between the driver and the GPU may reduce a bandwidth usage of a command stream when communicating instructions to the GPU in a computing device. For example, when an application configured according to an application program interface (API) outputs instructions to render a scene, a driver may communicate state objects to the GPU using a minimal amount of bandwidth to reduce an energy consumption of the computing device. More specifically, rather than explicitly communicating each state object to the GPU, the driver may identify a non-unique state of unique state objects that are to be transmitted to the GPU for the scene using an identifier. In this manner, the driver reduces a bandwidth of the command stream used to render the scene since the GPU may, in response to receiving the identifier, retrieve, outside the command stream, the non-unique state of unique state objects from an on-chip cache of the GPU, or from another cache of the computing device.

In some examples, the techniques described herein may leverage commonalities between state objects (e.g., blend states). For example, individual state objects may be duplicated across multiple pipeline state objects. Rather than explicitly repeating instructions for each instance of non-unique states (e.g., a state to be used multiple times for rendering a scene), one or more techniques described herein may permit use of an identifier that allows the GPU to access instructions outside of a command buffer, for instance, by accessing an on-chip cache of the GPU. In this way, bandwidth usage of the GPU may be reduced, thereby reducing a power consumption of the computing device.

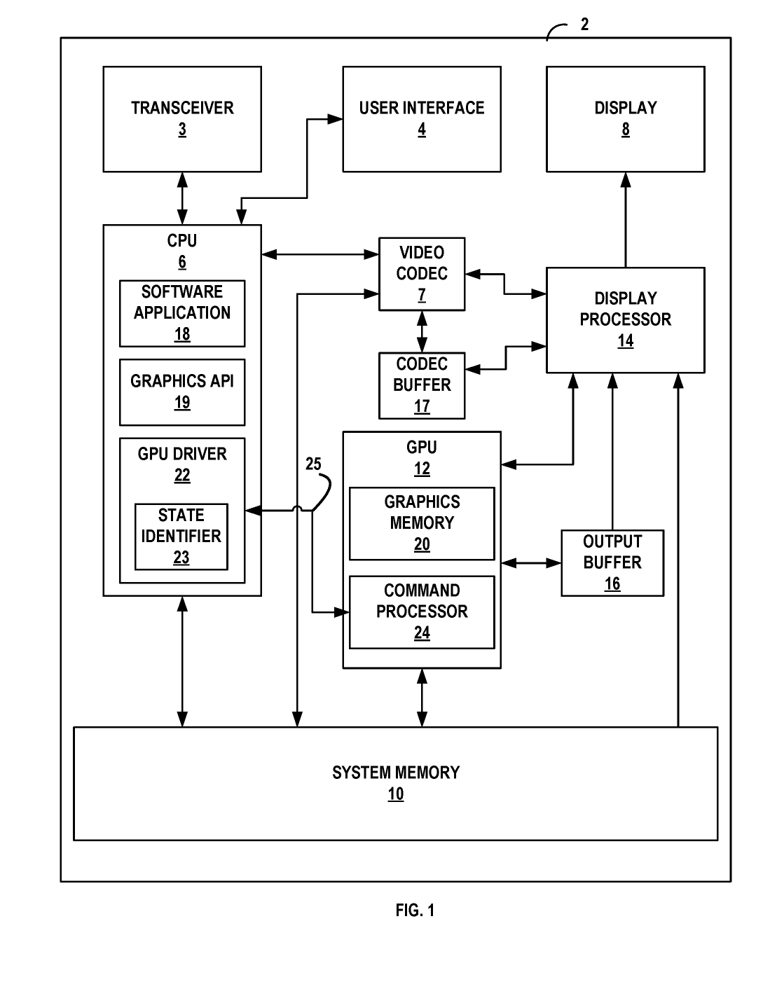

FIG. 1 is a block diagram illustrating an example computing device 2 that may be configured to implement one or more aspects of this disclosure. As shown in FIG. 1, computing device 2 may be, for example, a personal computer, a desktop computer, a laptop computer, a tablet computer, a computer workstation, a video game platform or console, a mobile telephone (e.g., a cellular or satellite telephone), a landline telephone, an Internet telephone, a handheld device (e.g., a portable video game device or a personal digital assistant (PDA)), a personal music player, a video player, a display device, a television, a television set-top box, a server, an intermediate network device, a mainframe computer, any mobile device, or any other type of device that processes and/or displays graphical data. In the example of FIG. 1, computing device 2 may include central processing unit (CPU) 6, system memory 10, and GPU 12. Computing device 2 may also include display processor 14, transceiver 3, user interface 4, video codec 7, and display 8. In some examples, video codec 7 may be a software application, such as a software application among the software application 18 configured to be processed by CPU 6 or other components of computing device 2. In other examples, video codec 7 may be a hardware component different from CPU 6, a software application that runs on a component different from CPU 6, or a combination of hardware and software.

GPU 12 may be designed with a single instruction, multiple data (SIMD) structure. In the SIMD structure, GPU 12 may include a plurality of SIMD processing elements, where each SIMD processing element executes the same commands, but on different data. A particular command executing on a particular SIMD processing element is referred to as a thread. Each SIMD processing element may be considered as executing a different thread because the data for a given thread may be different; however, the thread executing on a processing element is the same command as the command executing on the other processing elements. In this way, the SIMD structure allows GPU 12 to perform many tasks in parallel (e.g., at the same time).

As will be described in more detail below, the techniques described herein may reduce a bandwidth usage of the command stream between a CPU and GPU to render a scene. By reducing the bandwidth usage of, and the amount of data sent by, a command stream between a CPU and GPU to render a scene, power and energy consumption in a computing device may be reduced. Additionally, techniques described herein may reduce an amount of data used to represent GPU program instruction bandwidth. Such program instructions may include, for example, shader instructions. As used herein, shader instructions may include a series of instructions stored in memory that represent a program that the GPU can execute. Since GPU program instructions may generate a variable amount of bandwidth between the GPU and an on-chip cache of the GPU or an off-chip cache of the GPU, any suitable instruction compression may be used to compress the GPU program instructions, for example, a Huffman-like algorithm. Examples of Huffman-like algorithms include, but are not limited to, n-ary Huffman, adaptive Huffman coding, Huffman template algorithm, length-limited coding, minimum variance Huffman coding, Huffman codding with unequal letter costs, optimal alphabetic binary trees, canonical Huffman code, or other Huffman-like algorithms. Such instruction compression to generate a variable amount of bandwidth consumption, may participate with the techniques described herein, thereby resulting in reduced power consumption of the computing device.

In some examples, system memory 10 is a non-transitory storage medium. The term “non-transitory” may indicate that the storage medium is not embodied in a carrier wave or a propagated signal. However, the term “non-transitory” should not be interpreted to mean that system memory 10 is non-movable or that its contents are static. As one example, system memory 10 may be removed from computing device 2, and moved to another device. As another example, memory, substantially similar to system memory 10, may be inserted into computing device 2. In certain examples, a non-transitory storage medium may store data that can, over time, change (e.g., in RAM).

While software application 18 is conceptually shown as inside CPU 6, it is understood that software application 18 may be stored in system memory 10, memory external to but accessible to computing device 2, or a combination thereof. The external memory may, for example, be continuously intermittently accessible to computing device 2.

Display processor 14 may utilize a tile-based architecture. In some examples, a tile is an area representation of pixels including a height and width with the height being one or more pixels and the width being one or more pixels. In such examples, tiles may be rectangular or square in nature. In other examples, a tile may be a shape different than a square or a rectangle. Display processor 14 may fetch multiple image layers (e.g., foreground and background) from at least one memory. For example, display processor 14 may fetch image layers from a frame buffer to which a GPU outputs graphical data in the form of pixel representations and/or other memory.

As another example, display processor 14 may fetch image layers from on-chip memory of video codec 7, on-chip memory of GPU 12, output buffer 16, codec buffer 17, and/or system memory 10). The multiple image layers may include foreground layers and/or background layers. As used herein, the term “image” is not intended to mean only a still image. Rather, an image or image layer may be associated with a still image (e.g., the image or image layers when blended may be the image) or a video (e.g., the image or image layers when blended may be a single image in a sequence of images that when viewed in sequence create a moving picture or video).

Display processor 14 may process pixels from multiple layers. Example pixel processing that may be performed by display processor 14 may include up-sampling, down-sampling, scaling, rotation, and other pixel processing. For example, display processor 14 may process pixels associated with foreground image layers and/or background image layers. Display processor 14 may blend pixels from multiple layers, and write back the blended pixels into memory in tile format. Then, the blended pixels are read from memory in raster format and sent to display 8 for presentment.

Video codec 7 may receive encoded video data. Computing device 2 may receive encoded video data from, for example, a storage medium, a network server, or a source device (e.g., a device that encoded the data or otherwise transmitted the encoded video data to computing device 2, such as a server). In other examples, computing device 2 may itself generate the encoded video data. For example, computing device 2 may include a camera for capturing still images or video. The captured data (e.g., video data) may be encoded by video codec 7. Encoded video data may include a variety of syntax elements generated by a video encoder for use by a video decoder, such as video codec 7, in decoding the video data.

While video codec 7 is described herein as being both a video encoder and video decoder, it is understood that video codec 7 may be a video decoder without encoding functionality in other examples. Video data decoded by video codec 7 may be sent directly to display processor 14, may be sent directly to display 8, or may be sent to memory accessible to display processor 14 or GPU 12 such as system memory 10, output buffer 16, or codec buffer 17. In the example shown, video codec 7 is connected to display processor 14, meaning that decoded video data is sent directly to display processor 14 and/or stored in memory accessible to display processor 14. In such an example, display processor 14 may issue one or more memory requests to obtain decoded video data from memory in a similar manner as when issuing one or more memory requests to obtain graphical (still image or video) data from memory (e.g., output buffer 16) associated with GPU 12.

Video codec 7 may operate according to a video compression standard, such as the ITU-T H.264, Advanced Video Coding (AVC), or ITU-T H.265, High Efficiency Video Coding (HEVC), standards. The techniques of this disclosure, however, are not limited to any particular coding standard.

Transceiver 3, video codec 7, and display processor 14 may be part of the same integrated circuit (IC) as CPU 6 and/or GPU 12, may be external to the IC or ICs that include CPU 6 and/or GPU 12, or may be formed in the IC that is external to the IC that includes CPU 6 and/or GPU 12. For example, video codec 7 may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof.

Computing device 2 may include additional modules or processing units not shown in FIG. 1 for purposes of clarity. For example, computing device 2 may include a speaker and a microphone, neither of which are shown in FIG. 1, to effectuate telephonic communications in examples where computing device 2 is a mobile wireless telephone, or a speaker where computing device 2 is a media player. Computing device 2 may also include a video camera. Furthermore, the various modules and units shown in computing device 2 may not be necessary in every example of computing device 2. For example, user interface 4 and display 8 may be external to computing device 2 in examples where computing device 2 is a desktop computer or other device that is equipped to interface with an external user interface or display.

Examples of user interface 4 include, but are not limited to, a trackball, a mouse, a keyboard, and other types of input devices. User interface 4 may also be a touch screen and may be incorporated as a part of display 8. Transceiver 3 may include circuitry to allow wireless or wired communication between computing device 2 and another device or a network. Transceiver 3 may include modulators, demodulators, amplifiers and other such circuitry for wired or wireless communication. In some examples, transceiver 3 may be integrated with CPU 6.

CPU 6 may be a microprocessor, such as a CPU configured to process instructions of a computer program for execution. CPU 6 may include a general-purpose or a special-purpose processor that controls operation of computing device 2. A user may provide input to computing device 2 to cause CPU 6 to execute one or more software applications, such as software application 18. The software application 18 that execute on CPU 6 (or on one or more other components of computing device 2) may include, for example, an operating system, a word processor application, an email application, a spreadsheet application, a media player application, a video game application, a graphical user interface application, or another type of software application that uses graphical data for 2D or 3D graphics. Additionally, CPU 6 may execute GPU driver 22 for controlling the operation of GPU 12. The user may provide input to computing device 2 via one or more input devices (not shown) such as a keyboard, a mouse, a microphone, a touch pad or another input device that is coupled to computing device 2 via user interface 4.

Software application 18 that executes on, for example, CPU 6, may include graphics rendering instructions that instruct CPU 6 to cause the rendering of graphics data to display 8. The software instructions may include an instruction to process 3D graphics as well as an instruction to process 2D graphics. In some examples, the software instructions may conform to a graphics API 19. Graphics API 19 may be, for example, an Open Graphics Library (OpenGL®) API, an Open Graphics Library Embedded Systems (OpenGL ES) API, a Direct3D API, a WebGL API, an Open Computing Language (OpenCL™), or any other public or proprietary standard GPU compute API. In order to process the graphics rendering instructions of software application 18 executing on CPU 6, CPU 6, during execution of software application 18, may issue one or more graphics rendering commands to GPU 12 (e.g., through GPU driver 22) to cause GPU 12 to perform some or all of the rendering of the graphics data. In some examples, the graphics data to be rendered may include a list of graphics primitives, for example, but not limited to, points, lines, triangles, quadrilaterals, triangle strips, or other graphics primitives.

Software application 18 may include one or more drawing instructions that instruct GPU 12 to render a graphical user interface (GUI), a graphics scene, graphical data, or other graphics related data. For example, the drawing instructions may include instructions that define a set of one or more graphics primitives to be rendered by GPU 12. In some examples, the drawing instructions may, collectively, define all or part of a plurality of windowing surfaces used in a GUI. In additional examples, the drawing instructions may, collectively, define all or part of a graphics scene that includes one or more graphics objects within a model space or world space defined by the application.

GPU 12 may be configured to perform graphics operations to render one or more graphics primitives to display 8. Thus, when software application 18 executing on CPU 6 requires graphics processing, CPU 6 may provide graphics rendering commands along with graphics data to GPU 12 for rendering to display 8. The graphics data may include, for example, but not limited to, drawing commands, state information, primitive information, texture information, or other graphics data. GPU 12 may, in some instances, be built with a highly-parallel structure that provides more efficient processing of complex graphic-related operations than CPU 6. For example, GPU 12 may include a plurality of processing elements, such as shader units, that are configured to operate on multiple vertices or pixels in a parallel manner. The highly parallel nature of GPU 12 may, in some examples, allow GPU 12 to draw graphics images (e.g., GUIs and two-dimensional (2D) and/or three-dimensional (3D) graphics scenes) onto display 8 more quickly than drawing the scenes directly to display 8 using CPU 6.

Software application 18 may invoke GPU driver 22, to issue one or more commands to GPU 12 for rendering one or more graphics primitives into displayable graphics images (e.g., displayable graphical data). For example, software application 18 may, when executed, invoke GPU driver 22 to provide primitive definitions to GPU 12. In some instances, the primitive definitions may be provided to GPU 12 in the form of a list of drawing primitives, for example, but not limited to, triangles, rectangles, triangle fans, triangle strips, or another drawing primitive. The primitive definitions may include vertex specifications that specify one or more vertices associated with the primitives to be rendered. The vertex specifications may include positional coordinates for each vertex and, in some instances, other attributes associated with the vertex, such as, e.g., color coordinates, normal vectors, and texture coordinates. The primitive definitions may also include primitive type information (for example, but not limited to, triangle, rectangle, triangle fan, triangle strip, or type of primitive information), scaling information, rotation information, and the like.

Based on the instructions issued by software application 18 to GPU driver 22, GPU driver 22 may formulate one or more commands that specify one or more operations for GPU 12 to perform in order to render the primitive. When GPU 12 receives a command from CPU 6, a graphics processing pipeline may execute on shader processors of GPU 12 to decode the command and to configure a graphics processing pipeline to perform the operation specified in the command. For example, an input-assembler in the graphics processing pipeline may read primitive data and assemble the data into primitives for use by the other graphics pipeline stages in a graphics processing pipeline. After performing the specified operations, the graphics processing pipeline outputs the rendered data to output buffer 16 accessible to display processor 14. In some examples, the graphics processing pipeline may include fixed function logic and/or be executed on programmable shader cores.

Output buffer 16 stores destination pixels for GPU 12 and/or video codec 7 depending on the example. Each destination pixel may be associated with a unique screen pixel location. Similarly, codec buffer 17 may store destination pixels for video codec 7 depending on the example. Codec buffer 17 may be considered a frame buffer associated with video codec 7. In some examples, output buffer 16 and/or codec buffer 17 may store color components and a destination alpha value for each destination pixel. For example, output buffer 16 and/or codec buffer 17 may store pixel data according to any format. For example, output buffer 16 and/or codec buffer 17 may store Red, Green, Blue, Alpha (RGBA) components for each pixel where the “RGB” components correspond to color values and the “A” component corresponds to a destination alpha value. As another example, output buffer 16 and/or codec buffer 17 may store pixel data according to the YCbCr color format, YUV color format, RGB color format, or according to any other color format. Although output buffer 16 and system memory 10 are illustrated as being separate memory units, in other examples, output buffer 16 may be part of system memory 10. For example, output buffer 16 may be allocated memory space in system memory 10. Output buffer 16 may constitute a frame buffer. Further, as discussed above, output buffer 16 may also be able to store any suitable data other than pixels.

Similarly, although codec buffer 17 and system memory 10 are illustrated as being separate memory units, in other examples, codec buffer 17 may be part of system memory 10. For example, codec buffer 17 may be allocated memory space in system memory 10. Codec buffer 17 may constitute a video codec buffer or a frame buffer. Further, as discussed above, codec buffer 17 may also be able to store any suitable data other than pixels. In some examples, although output buffer 16 and codec buffer 17 are illustrated as being separate memory units, output buffer 16 and codec buffer 17 may be the same buffer or different parts of the same buffer.

GPU 12 may, in some instances, be integrated into a motherboard of computing device 2. In other instances, GPU 12 may be present on a graphics card that is installed in a port in the motherboard of computing device 2 or may be otherwise incorporated within a peripheral device configured to interoperate with computing device 2. In some examples, GPU 12 may be on-chip with CPU 6, such as in a system on chip (SOC) GPU 12 may include one or more processors, such as one or more microprocessors, application specific integrated circuits (ASICs), field programmable gate arrays (FPGAs), digital signal processors (DSPs), or other equivalent integrated or discrete logic circuitry. GPU 12 may also include one or more processor cores, so that GPU 12 may be referred to as a multi-core processor. In some examples, GPU 12 may be specialized hardware that includes integrated and/or discrete logic circuitry that provides GPU 12 with massive parallel processing capabilities suitable for graphics processing. In some instances, GPU 12 may also include general-purpose processing capabilities, and may be referred to as a general-purpose GPU (GPGPU) when implementing general-purpose processing tasks (e.g., so-called “compute” tasks).

In some examples, graphics memory 20 may be an internal cache of GPU 12. For example, graphics memory 20 may be on-chip memory or memory that is physically integrated into the integrated circuit chip of GPU 12. If graphics memory 20 is on-chip, GPU 12 may be able to read values from or write values to graphics memory 20 more quickly than reading values from or writing values to system memory 10 via a system bus. Thus, GPU 12 may read data from and write data to graphics memory 20 without using a bus. In other words, GPU 12 may process data locally using a local storage, instead of off-chip memory. Such graphics memory 20 may be referred to as on-chip memory. This allows GPU 12 to operate in a more efficient manner by eliminating the need of GPU 12 to read and write data via a bus, which may experience heavy bus traffic and associated contention for bandwidth. In some instances, however, GPU 12 may not include a separate memory, but instead utilize system memory 10 via a bus. Graphics memory 20 may include one or more volatile or non-volatile memories or storage devices, such as, e.g., random access memory (RAM), static RAM (SRAM), dynamic RAM (DRAM), erasable programmable ROM (EPROM), electrically erasable programmable ROM (EEPROM), Flash memory, a magnetic data media or an optical storage media.

In some examples, GPU 12 may store a fully formed image in system memory 10. Display processor 14 may retrieve the image from system memory 10 and/or output buffer 16 and output values that cause the pixels of display 8 to illuminate to display the image. In some examples, display processor 14 may be configured to perform 2D operations on data to be displayed, including scaling, rotation, blending, and compositing. Display 8 may be the display of computing device 2 that displays the image content generated by GPU 12. Display 8 may be a liquid crystal display (LCD), an organic light emitting diode display (OLED), a cathode ray tube (CRT) display, a plasma display, or another type of display device. In some examples, display 8 may be integrated within computing device 2. For instance, display 8 may be a screen of a mobile telephone. In other examples, display 8 may be a stand-alone device coupled to computing device 2 via a wired or wireless communications link. For example, display 8 may be a computer monitor or flat panel display connected to a computing device (for example, but not limited to, a personal computer, a mobile computer, a tablet, a mobile phone, or another computing device) via a cable or wireless link.

CPU 6 processes instructions for execution within computing device 2. CPU 6 may generate a command stream 25 using a driver (e.g., GPU driver 22 which may be implemented in software executed by CPU 6) for execution by GPU 12. That is, CPU 6 may generate a command stream 25 that defines a set of operations to be performed by GPU 12.

CPU 6 may generate command stream 25 to be executed by GPU 12 that causes viewable content to be displayed on display 8. For example, CPU 6 may generate command stream 25 that provides instructions for GPU 12 to render graphics data that may be stored in output buffer 16 for display at display 8. In this example, CPU 6 may generate command stream 25 that is executed by a graphics rendering pipeline of GPU 12.

Additionally, or alternatively, CPU 6 may generate command stream 25 to be executed by GPU 12 that causes GPU 12 to perform other operations. For example, in some instances, CPU 6 may be a host processor that generates command stream 25 for using GPU 12 as a general purpose graphics processing unit (GPGPU). In this way, GPU 12 may act as a secondary processor for CPU 6. For example, GPU 12 may carry out a variety of general purpose computing functions traditionally carried out by CPU 6. Examples include a variety of image processing functions, including video decoding and post processing (e.g., de-blocking, noise reduction, color correction, and the like) and other application specific image processing functions (e.g., facial detection/recognition, pattern recognition, wavelet transforms, and the like).

In some examples, GPU 12 may collaborate with CPU 6 to execute such GPGPU applications. For example, CPU 6 may offload certain functions to GPU 12 by providing GPU 12 with command stream 25 for execution by GPU 12. In this example, CPU 6 may be a host processor and GPU 12 may be a secondary processor. CPU 6 may communicate with GPU 12 to direct GPU 12 to execute GPGPU applications via GPU driver 22.

GPU driver 22 may communicate, to GPU 12, command stream 25 that may be executed by shader units of GPU 12. In some examples, GPU driver 22 may be software. For example, GPU driver 22 may be implemented in uCode. In some examples, GPU driver 22 may be hardware. In some examples, GPU driver 22 may be a combination of hardware and software. GPU 12 may include command processor 24 that may receive command stream 25 from GPU driver 22. Command processor 24 may be any combination of hardware and software configured to receive and process command stream 25. As such, command processor 24 may be a stream processor. In some examples, instead of command processor 24, any other suitable stream processor may be usable in place of command processor 24 to receive and process command stream 25 and to perform the techniques disclosed herein. In one example, command processor 24 may be a hardware processor. In the example shown in FIG. 1, command processor 24 may be included in GPU 12. In other examples, command processor 24 may be a unit that is separate from CPU 6 and GPU 12. Command processor 24 may also be known as a stream processor, command/stream processor, and the like to indicate that it may be any processor configured to receive streams of commands and/or operations.

Command processor 24 may process command stream 25 including scheduling operations included in command stream 25 for execution by GPU 12. Specifically, command processor 24 may process command stream 25 and schedule the operations in command stream 25 for execution by shader units. In operation, GPU driver 22 may send to command processor 24 command stream 25, which may include a series of operations to be executed by GPU 12. Command processor 24 may receive the stream of operations that include command stream 25 and may process the operations of command stream 25 sequentially based on the order of the operations in command stream 25 and may schedule the operations in command stream 25 for execution by shader processors of shader units of GPU 12.

State identifier 23 may identify a non-unique state of unique state objects that are to be transmitted, via command stream 25, to GPU 12 for a scene using an identifier instead of explicitly repeating instructions for each instance of the non-unique state. In this manner, GPU driver 22 may reduce a bandwidth of command stream 25 to render the scene since GPU 12 may, in response to receiving the identifier, retrieve the non-unique state of unique state objects from an on-chip cache of the GPU, or retrieve the state object from another cache of the computing device 2. In some examples, state identifier 23 may be software. For example, state identifier 23 may be implemented in uCode. In some examples, state identifier 23 may be hardware. In some examples, state identifier 23 may be a combination of hardware and software.

In some examples, the techniques of this disclosure may permit GPU driver 22 to efficiently communicate, via command stream 25, state objects and command stream information to GPU 12. Such communication of state objects and command stream information between GPU driver 22 and GPU 12 may reduce a bandwidth usage of command stream 25 when communicating instructions to GPU 12 in a computing device 2.

For example, GPU driver 22 receives, for output to GPU 12, from software application 18, a set of instructions to render a scene. Responsive to receiving the set of instructions to render the scene, GPU driver 22 may determine whether the set of instructions includes a state object that is registered as corresponding to an identifier. For instance, GPU driver 22 may compare the set of instructions with one or more state objects registered in system memory 10 as corresponding to a respective identifier.

Responsive to determining that the set of instructions includes the state object that is registered as corresponding to the identifier, GPU driver 22 may output, to GPU 12, the identifier that corresponds to the state object and refrain from outputting the state object that is registered as corresponding to an identifier. For instance, rather than explicitly communicating, via command stream 25, the entire state object, which may be significantly larger than the identifier, the GPU driver 22, outputs, to GPU 12, only the identifier corresponding to the state object and refrains from outputting the state object.

However, responsive to determining that the set of instructions does not include the state object that is registered as corresponding to the identifier, GPU driver 22 may refrain from outputting, to the GPU 12, the identifier. For example, in those cases where an object of the set of instructions is unique, GPU driver 22 may output, via command stream 25, the entire state object without using an identifier. In some instances, state objects may not be registered as corresponding to an identifier when a state object is unique.

In this manner, GPU driver 22 reduces a bandwidth of command stream 25 used to render the scene since GPU 12 may, in response to receiving the identifier, retrieve the state object outside of command stream 25 rather than relying on receiving, from GPU driver 22, via command stream 25, the state object. More specifically, GPU 12 may retrieve the state object from graphics memory 20 of GPU 12, from system memory 10, or from another cache of computing device 2.

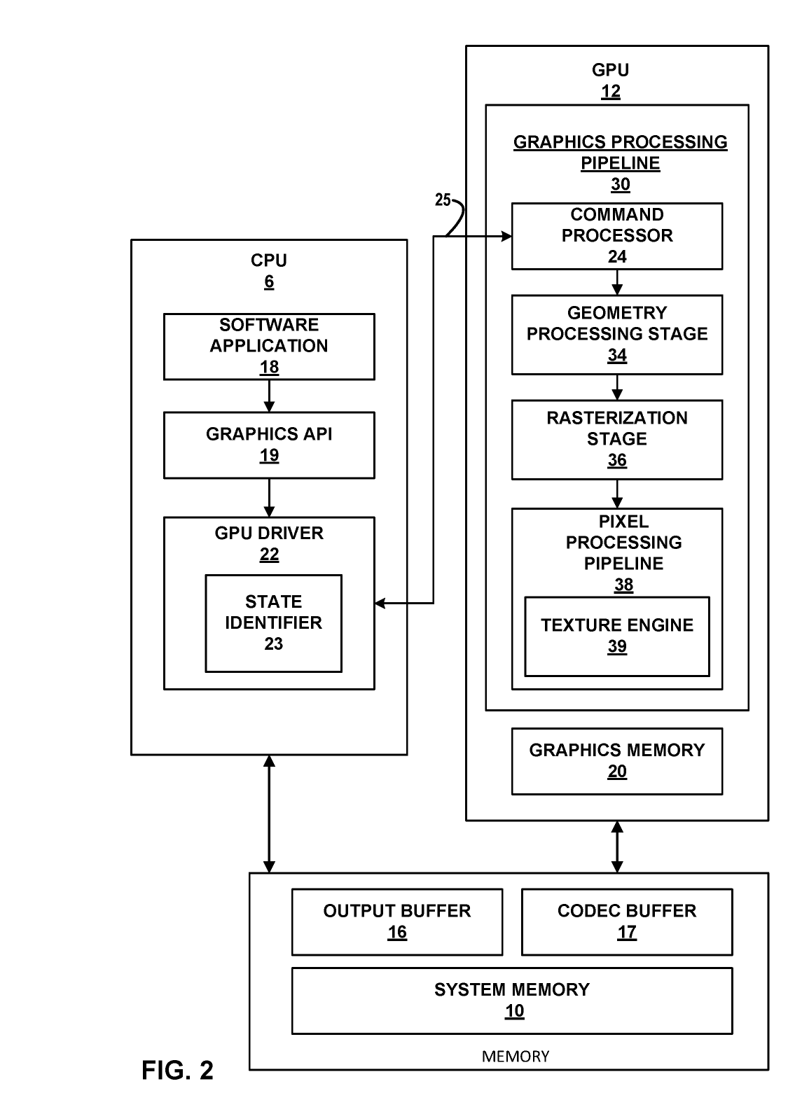

FIG. 2 is a block diagram illustrating example implementations of CPU 6, GPU 12, and system memory 10 of FIG. 1 in further detail. CPU 6 may include software application 18, graphics API 19, and GPU driver 22, each of which may be one or more software applications or services that execute on CPU 6. GPU 12 may include graphics processing pipeline 30 that includes a plurality of graphics processing stages that operate together to execute graphics processing commands. Graphics processing pipeline 30 is one example of a graphics processing pipeline, and this disclosure applies to any other graphics processing or graphics processing pipeline. GPU 12 may be configured to execute graphics processing pipeline 30 in a variety of rendering modes, including a binning rendering mode and a direct rendering mode. During rendering, each process may have corresponding context information. Context information may include information corresponding to a process associated with graphics processing pipeline 30. For example, such a process may be a graphics processing pipeline 30 process.

As shown in FIG. 2, graphics processing pipeline 30 may include command processor 24, geometry processing stage 34, rasterization stage 36, and pixel processing pipeline 38. Pixel processing pipeline 38 may include texture engine 39. Each of the components in graphics processing pipeline 30 may be implemented as fixed-function components, programmable components (e.g., as part of a shader program executing on a programmable shader unit), or as a combination of fixed-function and programmable components. Memory available to or otherwise accessible to CPU 6 and GPU 12 may include, for example, system memory 10, output buffer 16, codec buffer 17, and any on-chip memory of CPU 6, and any on-chip memory of GPU 12. Output buffer 16, which may be termed a frame buffer in some examples, may store rendered image data.

Software application 18 may be any application that utilizes any functionality of GPU 12 or that does not utilize any functionality of GPU 12. For example, software application 18 may be any application where execution by CPU 6 causes (or does not cause) one or more commands to be offloaded to GPU 12 for processing. Examples of software application 18 may include an application that causes CPU 6 to offload 3D rendering commands to GPU 12 (e.g., a video game application), an application that causes CPU 6 to offload 2D rendering commands to GPU 12 (e.g., a user interface application), or an application that causes CPU 6 to offload general compute tasks to GPU 12 (e.g., a GPGPU application). As another example, software application 18 may include firmware resident on any component of computing device 2, such as CPU 6, GPU 12, display processor 14, or any other component. Firmware may or may not utilize or invoke the functionality of GPU 12.

Software application 18 may include one or more drawing instructions that instruct GPU 12 to render a graphical user interface (GUI) and/or a graphics scene. For example, the drawing instructions may include instructions that define a set of one or more graphics primitives to be rendered by GPU 12. In some examples, the drawing instructions may, collectively, define all or part of a plurality of windowing surfaces used in a GUI. In additional examples, the drawing instructions may, collectively, define all or part of a graphics scene that includes one or more graphics objects within a model space or world space defined by the application.

Software application 18 may invoke GPU driver 22, via graphics API 19, to issue, via command stream 25, a command to GPU 12 for rendering a graphics primitive into displayable graphics images. For example, software application 18 may invoke GPU driver 22, via graphics API 19, to provide, via command stream 25, primitive definitions to GPU 12. In some instances, the primitive definitions may be provided to GPU 12 in the form of a list of drawing primitives, for example, but not limited to, triangles, rectangles, triangle fans, triangle strips, or another drawing primitive. The primitive definitions may include vertex specifications that specify one or more vertices associated with the primitives to be rendered.

The vertex specifications may include positional coordinates for each vertex and, in some instances, other attributes associated with the vertex, such as, for example, but not limited to, color coordinates, normal vectors, and texture coordinates. The primitive definitions may also include primitive type information (for example, but not limited to, triangle, rectangle, triangle fan, triangle strip, or another type of primitive information), scaling information, rotation information, and the like. Based on the instructions issued by software application 18 to GPU driver 22, GPU driver 22 may formulate one or more commands that specify one or more operations for GPU 12 to perform in order to render the primitive. When GPU 12 receives a command from CPU 6, graphics processing pipeline 30 decodes the command and configures one or more processing elements within graphics processing pipeline 30 to perform the operation specified in the command. After performing the specified operations, graphics processing pipeline 30 outputs the rendered data to memory (e.g., output buffer 16) accessible by display processor 14. Graphics processing pipeline 30 may be configured to execute in one of a plurality of different rendering modes, including a binning rendering mode and a direct rendering mode.

GPU driver 22 may be further configured to compile a shader program, and to output, via command stream 25, the compiled shader program onto one or more programmable shader units contained within GPU 12. The shader program may be written in a high level shading language, for example, but not limited to, an OpenGL Shading Language (GLSL), a High Level Shading Language (HLSL), a C for Graphics (Cg) shading language, or another high level shading language. The compiled shader programs may include an instruction that controls the operation of a programmable shader unit within GPU 12. For example, the shader program may include a vertex shader program and/or a pixel shader program. A vertex shader program may control the execution of a programmable vertex shader unit or a unified shader unit, and include instructions that specify one or more per-vertex operations. A pixel shader program may include pixel shader programs that control the execution of a programmable pixel shader unit or a unified shader unit, and include instructions that specify one or more per-pixel operations.

Graphics processing pipeline 30 may be configured to receive a graphics processing command from CPU 6, via GPU driver 22, and to execute the graphics processing commands to generate displayable graphics images. As discussed above, graphics processing pipeline 30 includes a plurality of stages that operate together to execute graphics processing commands. It should be noted, however, that such stages need not necessarily be implemented in separate hardware blocks. For example, portions of geometry processing stage 34 and pixel processing pipeline 38 may be implemented as part of a unified shader unit. Graphics processing pipeline 30 may be configured to execute in one of a group of different rendering modes, including a binning rendering mode and a direct rendering mode.

Command processor 24 may receive, via command stream 25, graphics processing commands and may configure the remaining processing stages within graphics processing pipeline 30 to perform various operations for carrying out the graphics processing commands. The graphics processing commands may include, for example, but not limited to, a drawing command, a graphics state command, or another graphics processing command. The drawing command may include a vertex specification command that specifies positional coordinates for one or more vertices and, in some instances, other attribute values associated with each of the vertices, such as, for example, but not limited to, color coordinates, normal vectors, texture coordinates, fog coordinates, or other attribute values associated with each of the vertices. The graphics state commands may include a primitive type command, a transformation command, a lighting command, or another graphics state command. The primitive type command may specify the type of primitive to be rendered and/or how the vertices are combined to form a primitive. The transformation command may specify the types of transformations to perform on the vertices. The lighting command may specify the type, direction and/or placement of different lights within a graphics scene. Command processor 24 may cause geometry processing stage 34 to perform geometry processing with respect to vertices and/or primitives associated with one or more received commands.

Geometry processing stage 34 may perform per-vertex operations and/or primitive setup operations on one or more vertices in order to generate primitive data for rasterization stage 36. Each vertex may be associated with a set of attributes, such as, for example, but not limited to, positional coordinates, color values, a normal vector, and texture coordinates. Geometry processing stage 34 may modify one or more of these attributes according to various per-vertex operations. For example, geometry processing stage 34 may perform a transformation on vertex positional coordinates to produce modified vertex positional coordinates. Geometry processing stage 34 may, for example, apply one or more of a modeling transformation, a viewing transformation, a projection transformation, a ModelView transformation, a ModelViewProjection transformation, a viewport transformation, a depth range scaling transformation, or another transformation to the vertex positional coordinates to generate the modified vertex positional coordinates. In some instances, the vertex positional coordinates may be model space coordinates, and the modified vertex positional coordinates may be screen space coordinates. The screen space coordinates may be obtained after the application of the modeling, viewing, projection and viewport transformations. In some instances, geometry processing stage 34 may also perform per-vertex lighting operations on the vertices to generate modified color coordinates for the vertices. Geometry processing stage 34 may also perform other operations including, for example, but not limited to, normal transformations, normal normalization operations, view volume clipping, homogenous division, and/or backface culling operations.

Geometry processing stage 34 may produce primitive data that includes a set of one or more modified vertices that define a primitive to be rasterized as well as data that specifies how the vertices combine to form a primitive. Each of the modified vertices may include, for example, but not limited to, modified vertex positional coordinates and processed vertex attribute values associated with the vertex. The primitive data may collectively correspond to a primitive to be rasterized by further stages of graphics processing pipeline 30. Conceptually, each vertex may correspond to a corner of a primitive where two edges of the primitive meet. Geometry processing stage 34 may provide the primitive data to rasterization stage 36 for further processing.

In some examples, all or part of geometry processing stage 34 may be implemented by one or more shader programs executing on one or more shader units. For example, geometry processing stage 34 may be implemented, in such examples, by a vertex shader, a geometry shader or any combination thereof. In other examples, geometry processing stage 34 may be implemented as a fixed-function hardware processing pipeline or as a combination of fixed-function hardware and one or more shader programs executing on one or more shader units.

Rasterization stage 36 is configured to receive, from geometry processing stage 34, primitive data that represents a primitive to be rasterized, and to rasterize the primitive to generate a plurality of source pixels that correspond to the rasterized primitive. In some examples, rasterization stage 36 may determine which screen pixel locations are covered by the primitive to be rasterized, and generate a source pixel for each screen pixel location determined to be covered by the primitive. Rasterization stage 36 may determine which screen pixel locations are covered by a primitive by using techniques such as, for example, but not limited to, an edge-walking technique, evaluating edge equations, or the like. Rasterization stage 36 may provide the resulting source pixels to pixel processing pipeline 38 for further processing.

The source pixels generated by rasterization stage 36 may correspond to a screen pixel location, for example, but not limited to, a destination pixel, and be associated with one or more color attributes. All of the source pixels generated for a specific rasterized primitive may be said to be associated with the rasterized primitive. The pixels that are determined by rasterization stage 36 to be covered by a primitive may conceptually include pixels that represent the vertices of the primitive, pixels that represent the edges of the primitive and pixels that represent the interior of the primitive.

Pixel processing pipeline 38 may be configured to receive a source pixel associated with a rasterized primitive, and to perform one or more per-pixel operations on the source pixel. Per-pixel operations that may be performed by pixel processing pipeline 38 may include, for example, but are not limited to, alpha test, texture mapping, color computation, pixel shading, per-pixel lighting, fog processing, blending, a pixel ownership test, a source alpha test, a stencil test, a depth test, a scissors test, stippling operations, or another per-pixel operation. In addition, pixel processing pipeline 38 may execute one or more pixel shader programs to perform one or more per-pixel operations. The resulting data produced by pixel processing pipeline 38 may be referred to herein as destination pixel data and stored in output buffer 16. The destination pixel data may be associated with a destination pixel in output buffer 16 that has the same display location as the source pixel that was processed. The destination pixel data may include data such as, for example, but not limited to, color values, destination alpha values, depth values, or other data.

Pixel processing pipeline 38 may include texture engine 39. Texture engine 39 may include both programmable and fixed function hardware designed to apply textures (texels) to pixels. Texture engine 39 may include dedicated hardware for performing texture filtering, whereby one or more texel values are multiplied by one or more pixel values and accumulated to produce the final texture mapped pixel.

In some examples, rather than the GPU driver 22 explicitly communicating, via command stream 25, each non-unique state of state objects, GPU driver 22 may communicate, via command stream 25, an identifier for each non-unique state of state objects. More specifically, state identifier 23 of GPU driver 22 may identify a non-unique state of unique state objects that are to be transmitted to GPU 12 for the scene using the identifier and GPU driver 22 may, rather than explicitly communicate the non-unique state, may simply communicate the identifier to indicate the non-unique state. In this manner, GPU driver 22 may reduce a bandwidth used to render the scene, since GPU 12 may, in response to receiving the identifier, retrieve the state object from graphics memory 20 of GPU 12, or retrieve the state object from system memory 10.

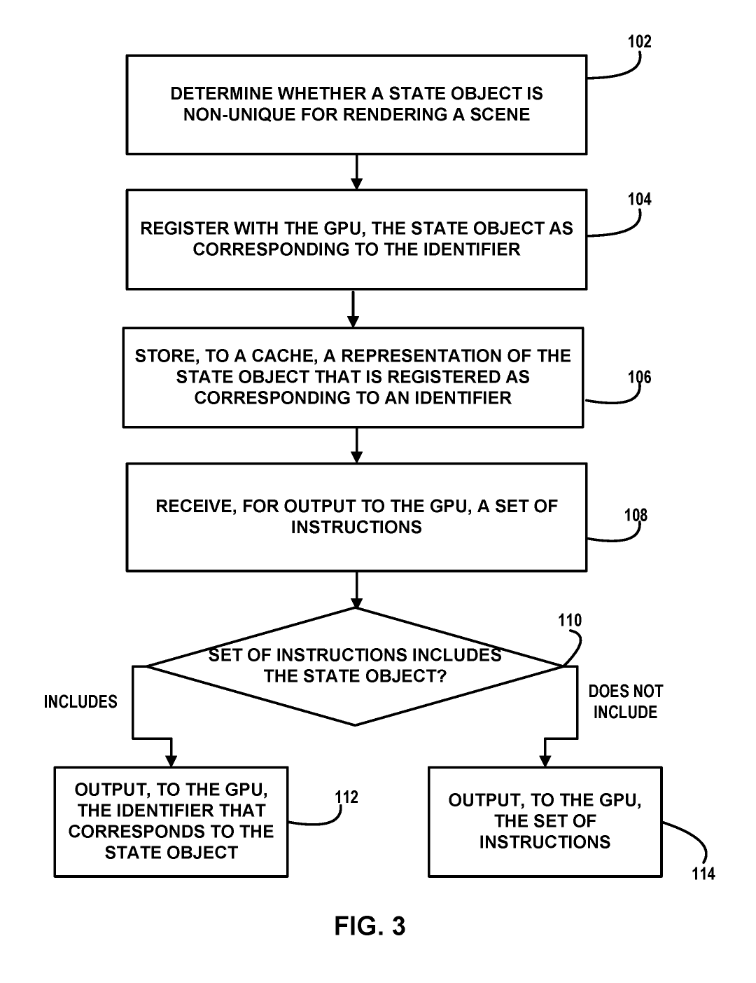

FIG. 3 is a flowchart showing an example method consistent with techniques of this disclosure. The method of FIG. 3 may be carried out by CPU 6 of FIG. 1 and/or CPU 6 of FIG. 2. In some examples, the method of FIG. 3 may be implemented in software. For example, the method of FIG. 3 may be implemented in uCode. In some examples, the method of FIG. 3 may be implemented in hardware. In some examples, the method of FIG. 3 may be implemented using a combination of hardware and software. CPU 6 may be configured to determine whether a state object is non-unique for rendering a scene (102). For example, GPU driver 22 of FIGS. 1-2 may cause CPU 6 to identify one or more state objects that are likely to be output, via command stream 25, by GPU driver 22, to GPU 12, when rendering a scene. For instance, GPU driver 22 identifies one or more state objects that GPU driver 22 determines are contained in a state grouping, such as, for instance, a blend state. More specifically, in some examples, GPU driver 22 may perform a full memory comparison of the state on CPU 6 to identify non-unique state objects. Additionally, or alternatively, GPU driver 22 may perform a hashing scheme to identify non-unique state objects.

Responsive to determining that the state object is non-unique when rendering the scene, CPU 6 may be configured to register, with the GPU 12, the state object as corresponding to the identifier (104). For example, GPU driver 22 may cause CPU 6 and/or GPU 12 to create, in system memory 10 and/or graphics memory 20, an entry identified by a unique identifier (e.g., not used in another entry) that indicates a location of the state object in system memory 10 and/or graphics memory 20. GPU driver 22 may cause CPU 6 and/or GPU 12 to store to a cache a representation of the state object that is registered as corresponding to the identifier (106). For example, GPU driver 22 may cause CPU 6 and/or GPU 12 to store, in system memory 10 and/or graphics memory 20, the state object in a compressed format at the location indicated in the entry identified by the unique identifier. In some examples, GPU driver 22 may cause CPU 6 and/or GPU 12 to store, in system memory 10 and/or graphics memory 20, the state object in an uncompressed format at the location indicated in the entry identified by the unique identifier.

GPU driver 22 may be configured to receive, for output to GPU 12, a set of instructions to render the scene (108). For example, software application 18, using one or more software instructions conforming to graphics API 19, may output, to GPU driver 22, a pipeline state object that includes multiple state objects and shader instructions to render the scene for output, via command stream 25, to command processor 24 of GPU 12.

Responsive to receiving the set of instructions to render the scene, GPU driver 22 may be configured to cause CPU 6 to determine whether the set of instructions includes the state object that is registered as corresponding to an identifier (110). For example, GPU driver 22 may compare instructions of the set of instructions to one or more instructions of the state object that is registered as corresponding to an identifier. In the example, GPU driver 22 determines, based on the comparison, whether the instructions of the set of instructions includes the one or more instructions of the state object that is registered as corresponding to an identifier. For instance, GPU driver 22 may determine that the set of instructions includes the state object that is registered as corresponding to an identifier when the GPU driver determines that the instructions of the set of instructions includes the one or more instructions of the state object that is registered as corresponding to an identifier.

Responsive to determining that the set of instructions includes the state object that is registered as corresponding to the identifier, GPU driver 22 may be configured to output, to the GPU 12, the identifier that corresponds to the state object (112). For example, rather than GPU driver 22, explicitly outputting, via command stream 25, to GPU 12, each instruction included in the state object that is registered as corresponding to the identifier, GPU driver 22 may output, via command stream 25, to GPU 12, the identifier that is registered as corresponding to the state object. Said differently, GPU driver 22 may refrain from outputting, to GPU 12, the state object that is registered as corresponding to an identifier and instead output, to GPU 12, the identifier that is registered as corresponding to the state object.

However, responsive to determining that the set of instructions does not include the state object that is registered as corresponding to the identifier, GPU driver 22 may be configured to output, to the GPU 12, the set of instructions (114). For example, GPU driver 22, explicitly outputs, via command stream 25, to GPU 12, each instruction included in the set of instructions and refrains from outputting to GPU 12, the identifier that is registered as corresponding to the state object.

In examples using multiple state objects that are each registered as corresponding to a respective identifier, GPU driver 22 may be configured to output, to the GPU 12, one or more identifiers registered as corresponding to the multiple state objects and one or more instructions of the set of instructions that are not included in a state object of the multiple state objects. For example, GPU driver 22, may output, via command stream 25, to GPU 12, a first identifier that is registered as corresponding to a first state object, a second identifier that is registered as corresponding to a second state object, and explicitly output, via command stream 25, to GPU 12, each instruction included in the set of instructions that are not included in the instructions for the first state object and instructions for the second state object.

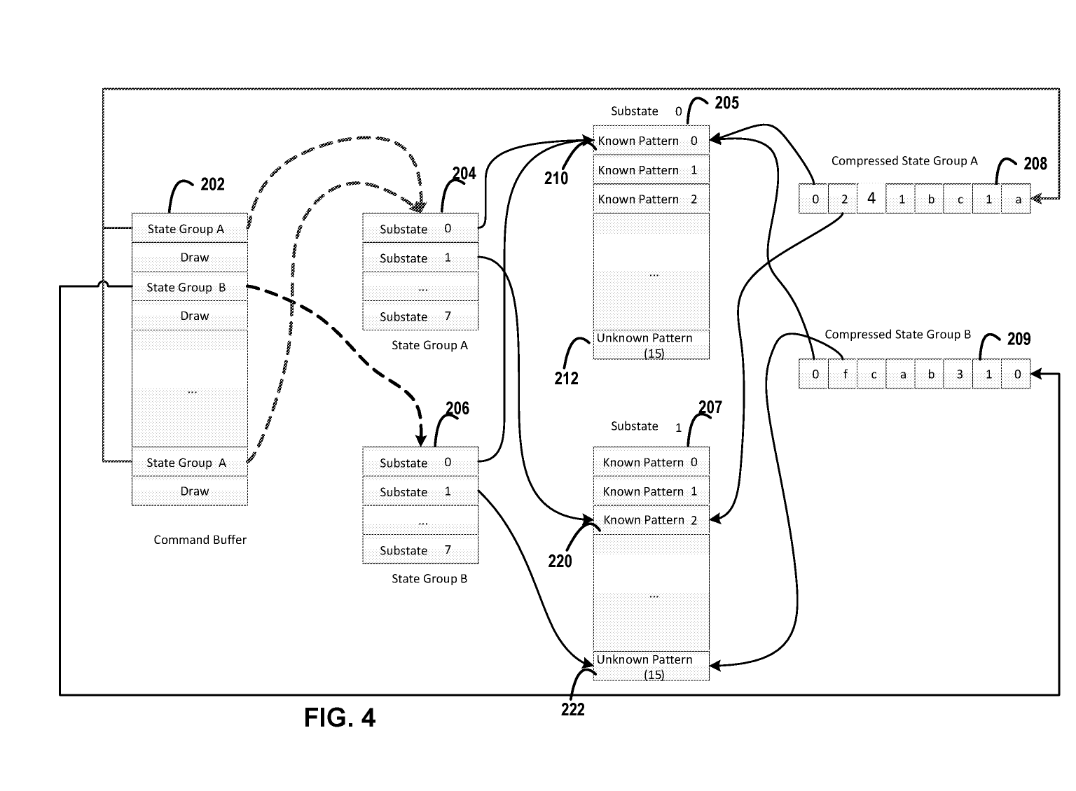

FIG. 4 is an illustration showing an operation consistent with techniques of this disclosure. The method of FIG. 4 may be carried out by CPU 6 of FIG. 1 and/or CPU 6 of FIG. 2. In the example of FIG. 4, GPU driver 22 may receive, for output to GPU 12, pipeline state object 202 for a command buffer to render a scene. Although, the example of FIG. 4 uses a pipeline state object GPU driver 22 may receive, for output to GPU 12, other types of data. As used herein, a pipeline state object may include multiple state objects and/or one or more shader instructions. As shown, pipeline state object 202 includes state group 204, which includes sub-state 205, and state group 206, which includes sub-state 207.

Rather than explicitly outputting, via command stream 25, each instruction of pipeline state object 202 to GPU 12, GPU driver 22 may determine whether the set of instructions includes a state object that is registered as corresponding to an identifier. For example, as shown, sub-state 205 includes known pattern 210 and unknown pattern 212 and sub-state 207 includes known pattern 220 and unknown pattern 222. As used herein, known pattern may refer to a pattern that is pre-registered with GPU 12 and that may be signaled, from the GPU driver 22, to GPU 12, via command stream 25, using an identifier. As used herein, unknown patter may refer to a pattern that is not pre-registered with GPU 12 and that may be signaled, from the GPU driver 22, to GPU 12, via command stream 25, explicitly.

In the example of FIG. 4, GPU driver 22 may determine that sub-state 205 includes known pattern 210 which is registered as corresponding to identifier ‘0’ (e.g., the byte “0000 0000”) and that sub-state 207 includes known pattern 220 which is registered as corresponding to identifier ‘0’. Accordingly, rather than GPU driver 22 outputting, to GPU 12, explicit instructions included in known pattern 210, GPU driver 22 outputs, to GPU 12, the identifier ‘0’. Similarity, rather than GPU driver 22 outputting, to GPU 12, explicit instructions included in known pattern 220, GPU driver 22 outputs, to GPU 12, the identifier ‘2’ (e.g., the byte “0000 0010”).

However, responsive to GPU driver 22 determining that sub-state 205 includes unknown pattern 212, which does not correspond to an identifier, GPU driver outputs, to GPU 12, explicit instructions included in unknown pattern 212 (e.g., the state “a”). Similarly, responsive to GPU driver 22 determining that sub-state 207 includes unknown pattern 222, which does not correspond to an identifier, GPU driver outputs, to GPU 12, explicit instructions included in unknown pattern 222 (e.g., the state “f”).

As shown, compressed state group 208 may include unique state ‘a’ for rendering the scene. In the example of FIG. 4, GPU driver 22 may compress the unique state ‘a’ and the identifier for state object ‘0’ (e.g., the byte “0000 0000”) to generate a compressed series of instructions that has fewer bits than a combination of bits to be used to form the identifier for state object ‘0’ and the unique state ‘a’. For instance, a Huffman-like algorithm may be used to compress the unique state ‘a’ and the identifier for state object ‘0’.

Further, GPU driver 22 may compress the unique state ‘a’, the identifier ‘0’, and the identifier ‘2’ (e.g., the byte “0000 0010”) to generate a compressed series of instructions that has fewer bits than a combination of bits to be used to form the identifier ‘0’, the identifier ‘2’, and unique state ‘a’. For instance, a Huffman-like algorithm may be used to compress the unique state ‘a’, the identifier ‘0’, and the identifier ‘2’. More specifically, for example, in response to determining that a shader matches a template, rather than assuming that an instruction uses a standard instruction width (e.g., 32 bits), GPU driver 22 may use a compact encoding of instructions for the entire shader (e.g., 1 byte). Additionally, or alternatively, in response to determining that a shader matches a template, GPU driver 22 may mark sections of the shader, where the sections of the shader are compressed.

In accordance with this disclosure, the term “or” may be interpreted as “and/or” where context does not dictate otherwise. Additionally, while phrases such as “one or more” or “at least one” or the like may have been used for some features disclosed herein but not others; the features for which such language was not used may be interpreted to have such a meaning implied where context does not dictate otherwise.

In one or more examples, the functions described herein may be implemented in hardware, software, firmware, or any combination thereof. For example, processing unit may be configured to perform any function described herein. As another example, although the term “processing unit” has been used throughout this disclosure, it is understood that such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can include RAM, ROM, EEPROM, CD-ROM or other optical disk storage, magnetic disk storage, or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” or “processing unit” as used herein may refer to any of the foregoing structure or any other structure suitable for implementation of the techniques described herein. In addition, in some aspects, the functionality described herein may be provided within dedicated hardware and/or software modules configured for context switching and/or parallel processing. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of compressing a graphic state, the method comprising:
receiving, by a driver, for output to a graphics processing unit (GPU), a set of instructions to render a scene;
responsive to receiving the set of instructions to render the scene, determining, by the driver, whether the set of instructions includes a state object that is registered as corresponding to an identifier; and
responsive to determining that the set of instructions includes the state object that is registered as corresponding to the identifier, outputting, by the driver, to the GPU, the identifier that is registered as corresponding to the state object.

2. The method of claim 1, further comprising:
responsive to determining that the set of instructions does not include the state object that is registered as corresponding to the identifier:
outputting, by the driver, to the GPU, the state object.

3. The method of claim 1, further comprising:
determining, prior to receiving the set of instructions, by the driver, whether the state object is non-unique; and
responsive to determining that the state object is non-unique, registering, by the driver, with the GPU, the state object as corresponding to the identifier.

4. The method of claim 3, further comprising:
storing, by the driver, to a cache, prior to receiving the set of instructions, a representation of the state object that is registered as corresponding to an identifier.

5. The method of claim 4, wherein the cache is an internal cache of the GPU.

6. The method of claim 4, wherein the cache is a cache external to the GPU.

7. The method of claim 3, further comprising:
determining whether the state object is included in a blend state; and
responsive to determining that the state object is included in the blend state, determining that the state object is non-unique.

8. The method of claim 1, wherein outputting the identifier that corresponds to the state object comprises:
determining at least one unique state object for rendering the scene; and
compressing the identifier with the at least one unique state object to generate a compressed series of instructions that has fewer bits than a combination of bits to be used to form the identifier and the at least one unique state object.

9. The method of claim 8, wherein outputting the identifier that corresponds to the state object further comprises:
determining at least one other identifier for rendering the scene,
wherein compressing the identifier with the at least one unique state object to generate a compressed series of instructions comprises compressing the identifier with the at least one unique state object and the at least one other identifier to generate the compressed series of instructions, and
wherein the compressed series of instructions has fewer bits than a combination of bits to be used to form the identifier, the at least one unique state object, and the at least one other identifier.

10. The method of claim 1, wherein the identifier has fewer bits than the state object that is registered as corresponding to the identifier.

11. A device comprising:
a graphics processing unit (GPU) configured to render a scene, wherein the graphics processing unit has an on-chip memory; and
a central processing unit (CPU) configured to:
receive, for output to the GPU, a set of instructions to render a scene;
responsive to receiving the set of instructions to render the scene, determine whether the set of instructions includes a state object that is registered as corresponding to an identifier; and
responsive to determining that the set of instructions includes the state object that is registered as corresponding to the identifier, output, to the GPU, the identifier that is registered as corresponding to the state object.

12. The device of claim 11, wherein the central processing unit is further configured to:
responsive to determining that the set of instructions does not include the state object that is registered as corresponding to the identifier:
output, to the GPU, the state object.

13. The device of claim 11, wherein the central processing unit is further configured to:
determine, prior to receiving the set of instructions, whether the state object is non-unique; and
responsive to determining that the state object is non-unique, register, with the GPU, the state object as corresponding to the identifier.

14. The device of claim 13, wherein the central processing unit is further configured to:
store, to the on-chip memory, prior to receiving the set of instructions, a representation of the state object that is registered as corresponding to an identifier.

15. The device of claim 13, further comprising:
a cache external to the GPU,
wherein the central processing unit is further configured to store, to the cache external to the GPU, prior to receiving the set of instructions, a representation of the state object that is associated with the identifier.

16. The device of claim 13, wherein the central processing unit is further configured to:
determine whether the state object is included in a blend state; and
responsive to determining that the state object is included in the blend state, determine that the state object is non-unique.

17. The device of claim 11, wherein the central processing unit is further configured to:
determine at least one unique state object for rendering the scene; and
compress the identifier with the at least one unique state object to generate a compressed series of instructions that has fewer bits than a combination of bits to be used to form the identifier and the at least one unique state object,
wherein outputting the identifier that corresponds to the state object comprises outputting the compressed series of instructions.

18. The device of claim 17, wherein the central processing unit is further configured to:
determine at least one other identifier for rendering the scene using the set of state objects,
wherein compressing the identifier with the at least one unique state object to generate a compressed series of instructions comprises compressing the identifier with the at least one unique state object and the at least one other identifier to generate the compressed series of instructions, and
wherein the compressed series of instructions has fewer bits than a combination of bits to be used to form the identifier, the at least one unique state object, and the at least one other identifier.

19. The device of claim 11, wherein the identifier has fewer bits than the state object that is registered as corresponding to an identifier.

20. A non-transitory computer-readable storage medium having instructions stored thereon that, when executed, cause one or more processors of a computing device to:
receive, for output to a graphics processing unit (GPU), a set of instructions to render a scene;
responsive to receiving the set of instructions to render the scene, determine whether the set of instructions includes a state object that is registered as corresponding to an identifier; and
responsive to determining that the set of instructions includes the state object that is registered as corresponding to the identifier, output, to the GPU, the identifier that corresponds to the state object.
